(19) United States
(12) Patent Application Publication
(10) Pub. No.: US 2022/0387256 A1
(43) Pub. Date: Dec. 8, 2022

(54) Vial With Metered Dispenser

(71) Applicant: Kent Byron, New Iberia, LA (US)

(72) Inventor: Kent Byron, New Iberia, LA (US)

(21) Appl. No.: 17/831,008

(22) Filed: Jun. 2, 2022

Related U.S. Application Data
(60) Provisional application No. 63/196,405, filed on Jun. 3, 2021.

(51) Int. Cl. A61J 1/06; G01F 11/08; B65B 61/02; B65B 3/00; B65B 7/06; B65D 35/44; B65D 83/00

(52) U.S. Cl. CPC A61J 1/067; G01F 11/082; B65B 61/025; B65B 3/003; B65B 7/06; B65D 35/44; B65D 83/0055; A61J 2200/76

(57) ABSTRACT

A polymer vial with a tubular body having a geometric shape including (i) a neck having an opening orifice, and (ii) a closed base formed by flattening and sealing a bottom edge of the tubular body. The vial will also include a snap off cap integrally formed on the neck and a liquid content contained in the tubular body. A plurality of dosage lines are printed on the tubular body, the dosage lines having a non-uniform spacing corresponding to the variable volume per unit length of the vial geometric shape. Each line corresponds to a dosage volume of the liquid content when the opening orifice is oriented in the vertically upward position.

### CROSS-REFERENCE TO RELATED APPLICATION

This application claims the benefit under 35 U.S.C § 119(e) of U.S. Provisional Application No. 63/196,405, filed Jun. 3, 2021, which is incorporated by reference herein in its entirety.

### BACKGROUND OF THE DISCLOSURE

Cannabidiol or CBD is used as a remedy for a variety of ailments. For example, CBD is used to treat pain, lessen inflammation, reduce anxiety or tension, and relieve nausea. CBD also shows promise in the treatment of acne, neurological disorders, and heart and circulatory conditions. CBD has also been studied for its beneficial role in the treatment of mental disorders, substance abuse, cancer, and diabetes.

CBD is extracted from marijuana or hemp plants as either an oil or powder, which is then mixed into compositions formulated as liquids, creams, or gels. The oil or powder can also be formulated into capsules and taken orally. Often, CBD is formulated as a tincture. The CBD is mixed with a carrier such as an organic oil. For example, a medium chain triglyceride or MCT is often used as the carrier. An example of a suitable MCT is one derived from coconut oil. The strength of the CBD may vary depending upon the amount mixed with the MCT and other ingredients. For example, each tincture may be formulated in strengths of 500 mg, 1000 mg, or 3000 mg.

Regardless of the potency, each tincture may be stored and delivered using, for example, a 1-ounce glass bottle containing 30, 1 ml servings. The bottle includes a dropper applicator that may include markers on it (0.25, 0.50, 0.75, and 1 ml). For a potency of 500 mg, each 1 ml drop contains approximately 16 mg of CBD. For a potency of 1000 mg, each 1 ml drop contains approximately 33 mg of CBD. For a potency of 3000 mg, each drop contains 100 mg of CBD. The drop is applied sublingually. Using the dropper applicator, the user presses and releases the rubber cap while the end of the glass tube of the dropper applicator is immersed in the composition. This causes the CBD composition to flow into the glass tube. The user then removes the dropper applicator from the bottle and places the end of the glass tube above the floor of his or her mouth. The user then presses the rubber cap which will cause the release from the dropper applicator of an amount of the CBD composition onto the floor of the mouth, beneath the tongue.

Dispensing the CBD composition using a glass bottle and dropper applicator has several drawbacks. For example, the bottle and dropper applicator are comparatively expensive to manufacture. Furthermore, the dropper applicator is difficult to use and dispensing 1 ml per drop is problematic. Accordingly, there is a need for a more economical CBD dispenser that accurately and consistently delivers a uniform amount of the CBD composition per drop.

### SUMMARY OF THE DISCLOSURE

The present disclosure relates to a new and improved dispenser for a CBD composition. The dispenser comprises a plastic and resealable vial. The vial is configured to accurately dispense a uniform amount of the CBD composition per drop. The vial also contains markings that accurately show each equal dosage dispensed from the vial (e.g., shown in 10 mg increments per serving). In preferred embodiments, the vial may contain 3 ml or 5 ml of the CBD composition.

### BRIEF DESCRIPTION OF THE DRAWINGS

FIG. 1 shows a connected packet of vials according to one embodiment of the present invention.

FIGS. 2A to 2D show different views of an individual vial corresponding to those illustrated in FIG. 1.

FIG. 3 shows an enlarged cross-sectional view of one embodiment of a vial cap.

FIG. 4 shows one embodiment of dosage lines which could be positioned on a vial.

FIG. 5 suggests how the vial cap could function to reseal a vial once opened.

### DETAILED DESCRIPTION OF THE DISCLOSURE

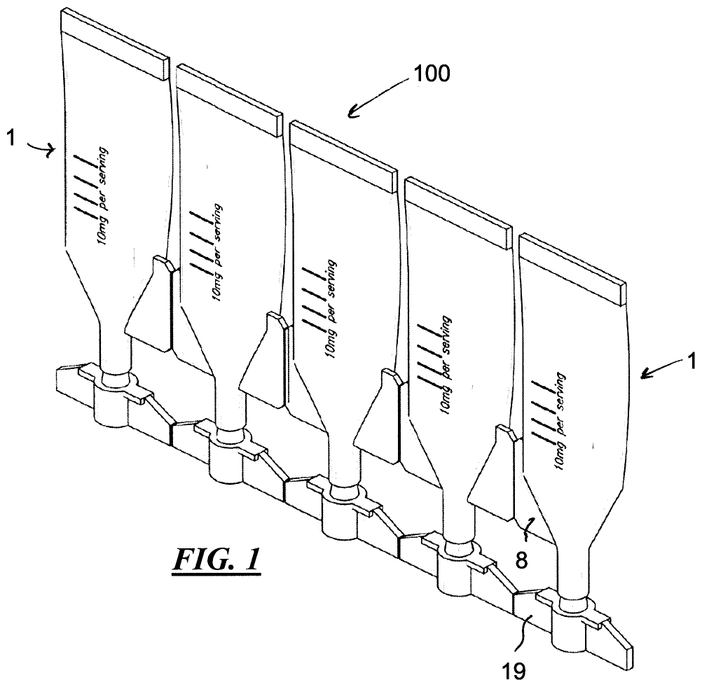

FIG. 1 illustrates one embodiment of the vials 1 formed into a vial packet 100 where the individual vials are connected by the connector tabs 8 and the grip wings 19. As is known in the art, connector tabs 8 will have weakened connections to the adjacent connector tab(s) so each vial may be separated from the others in the packet. The same weakened connection may be made between the adjacent grip wings 19. Typically, vial packet 100 is formed through an injection molding process using polymers suitable for such a process. One example polymer would be Marlex® metallocene linear low density polyethylene (mLLDPE) resin available from Chevron Phillips Chemical Company, LLC. Any suitable conventional or future developed molding technique could be employed to manufacture the vials, including those described in U.S. Pat. Nos. 6,101,791, 6,254,376, 6,572,359, 6,735,926, and 7,007,445, all of which are incorporated by reference herein in their entirety. Although vials with a liquid content of 3 ml or 5 ml are most common, vials having a capacity anywhere between 1 ml and 50 ml are possible.

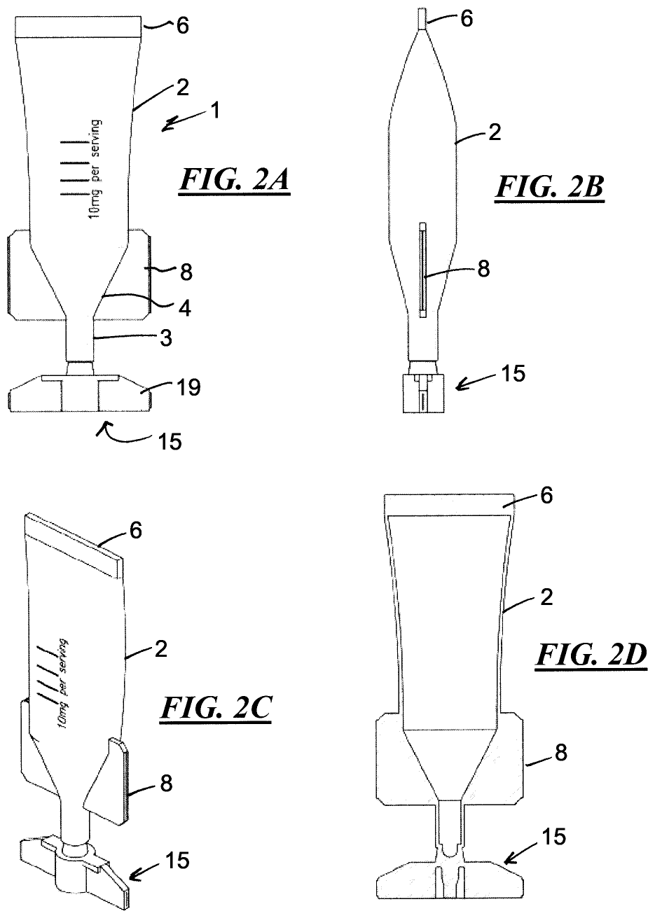

FIGS. 2A to 2D better show the features of the illustrated embodiment of the individual vials 1. Beginning with the main tubular body 2, the vials 1 will include the shoulder 4 transitioning from the tubular body 2 to neck 3. It will be understood that typically as part of the manufacturing process for vials 1, the end of tubular body 2 opposite neck 3 is initially formed as an open ended tube. Then the vial is filled with the intended liquid and the circular edge of the tube end is flattened together and heat sealed to form the closed base 6 seen in the figures. Connector tabs 8 will further be formed in the vicinity of shoulder 4.

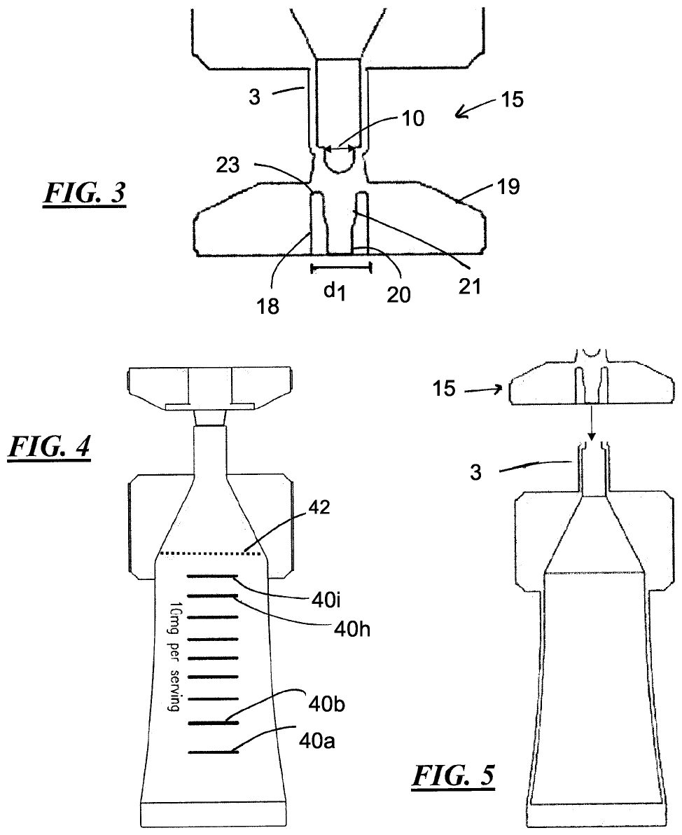

The snap off cap 15 will also be formed on neck 3. FIG. 3 best shows how cap 15 will attach at neck 3 at connector section 16 which includes thinner sidewalls to allow more ready separation of cap 15 from neck 3 at that location. The grip wings 19 will be formed on cap 15 to aid the user in applying the force needed to separate cap 15 from neck 3. In the illustrated embodiments, each grip wing has a width at least twice that of the closure aperture 18 (discussed further below). The inner diameter of neck 3 when cap 15 is removed at connector section 16 will form the opening orifice 10. In one embodiment, opening orifice 10 will have an inner diameter of approximately 0.1 inches and an outer diameter of 0.15 inches, but could include alternative inner diameters anywhere between 0.08 to 0.12 inches (and corresponding increases in the outer diameter). It has been discovered that an opening orifice of approximately 0.1 inches tends to dispense more uniform droplets than wider or narrower orifice diameters. The exact volume (and therefore mass) per droplet will vary depending on factors such as the specific gravity of the fluid being dispensed from the vial. For example, a droplet from the 0.1 opening orifice will be approximately 0.031 grams for water, but approximately 0.026 grams for a MCT (medium chain triglyceride) oil.

On the end of cap 15 opposite connector section 16 is formed the closure aperture 18. Closure aperture 18 only partially extends through cap 15, i.e., closure aperture 18 does not form a path all the way through cap 15 to connector section 16. As suggested in FIG. 3, an inner diameter di of closure aperture 18 will be slightly greater than an outer diameter of neck 3. Formed within closure aperture 18 is the center post 20. The end of center post 20 more proximate connector section 16 includes the expanding shoulder section 21. In a preferred embodiment, the end of center post 20 will be less in diameter than opening orifice 10, while the widest portion of the expanding shoulder 21 will be greater in diameter than the opening orifice 10. It is seen how a sealing channel 23 is formed between the inner diameter of the closure aperture 18 and an outer diameter of the post expanding shoulder 21. FIG. 5 suggests how closure aperture 18 may be placed over the open neck 3 to re-seal opening orifice 10. In this example, it will be understood that the wall thickness of the neck 3 is greater in width than the corresponding width of sealing channel 23. Thus, sealing channel 23 will tend to compress against both the outer surface and inner surface of the neck at opening orifice 10, thereby creating a dual seal when the sealing channel engages this upper end of neck 3.

FIG. 4 illustrates an embodiment where the vial includes a plurality of dosage lines 40 printed on the tubular body 2, with the lines representing equal amounts of liquid between the lines. In this embodiment, the dosage lines have a non-uniform spacing corresponding to the variable volume per unit length of the vial geometric shape. Those skilled in the art will recognize the geometric shape of the vial dictates that the volume per unit length of the valve body changes between the closed base 6, where the volume is less, and the opposite end of the body (e.g., prior to transitioning to shoulder 4), where the volume is greater. Thus, where FIG. 4 shows nine dosage lines 40, the distance between dosage lines 40a and 40b is greater than the distance between dosage lines 40h and 40i. It will be understood that because of this changing geometric shape, the intended orientation of the vial vertically up or down for reading purposed will change how the dosage lines 40 are oriented on the tubular body 2. FIG. 4 illustrates dosage lines corresponding to equal dosage volumes of the liquid content when the opening orifice is oriented in the vertically upward position. As used herein, “vertically upward” means in a direction opposite of the direction of the Earth's gravitational force. In the FIG. 4 example, the wider spacing between dosage lines 40a and 40b indicates that the liquid content of the vial relative to the dosage lines 40 is intended to be observed with the vial neck 3 oriented vertically upward. Also in FIG. 4, there are nine dosages lines 40 and a fluid content level 42 is shown as being one dosage volume above top dosage line 40i, i.e., the vial is shown as having ten equal unit doses. Naturally, other embodiments could have a different number of dosage lines 40, e.g., four dosage lines dividing the vial into five doses, or even a single line dividing the vial into two doses. Although the “effective ingredient” (or “active ingredient”) in this example is CBD, the effective ingredient could be any pharmaceutical, supplement, or other compound being manufactured for consumption.

In many examples, the dosage lines are spaced to represent a given volume of fluid which will correspond to a specified weight of effective ingredient, i.e., based on the concentration of effective ingredient in the fluid. For example, if the liquid in the FIG. 4 vial was a CBD carrying fluid with a concentration of 33 mg per ml, and there were three ml of the liquid in the vial, then the liquid between each of dosage lines 40 would represent approximately 10 mg of CBD. In many examples, this dosage between lines may also be referred to as “servings.”

In many embodiments, the printing on vials may be undertaken by the methods described in U.S. Pat. Nos. 7,124,681, 7,168,366, 7,389,725, 7,647,867, and 8,033,220, which are incorporated by reference herein in their entirety. The term “about” or “approximately” as used herein will typically mean a numerical value which is approximate and whose small variation would not significantly affect the practice of the disclosed embodiments. Where a numerical limitation is used, unless indicated otherwise by the context, “about” or “approximately” means the numerical value can vary by +/−5%, +/−10%, or in certain embodiments +/−15%, or possibly as much as +/−20%. Similarly, the term “substantially” will typically mean at least 85% to 99% of the characteristic modified by the term. For example, “substantially all” will mean at least 85%, at least 90%, or at least 95%, etc.

1. A method of marking dosages on a polymer vial, the method comprising the steps of:
(a) providing a polymer vial having a geometric shape in a sealed state, the polymer vial including an opening orifice covered by a snap off cap and an opposing base end;
(b) printing on the vial a plurality of non-uniformly spaced dosage lines;
(c) wherein the dosage lines represent equal dosages of liquid content in the vial when the vial is oriented with the opening orifice in approximately the vertically upward position.

2. The method of claim 1, wherein after printing of the dosage lines, a liquid content is placed into the vial and the base end is closed by flattening and sealing the base end.

3. The method of claim 2, wherein a dosage line spacing corresponds to a variable volume per unit length of the vial geometric shape with the base end closed.

4. The method of claim 3, wherein a the liquid content includes a concentration of effective ingredient, and the dosage line spacing corresponds to a given mg dosage of the effective ingredient.

5. The method of claim 4, wherein mg dosage is 10 mg.

6. The method of claim 1, wherein (i) the opening orifice has an inner diameter of between 0.09 and 0.11 inches, and (ii) the dosage line spacing corresponds to approximately 1 ml per dosage line.

7. The method of claim 6, wherein the snap off cap includes:
(i) a first end having a connector section configured to snap off of the neck upon application of force;
(ii) a second end having a closure aperture extending only partially into the first side of the cap, the closure aperture sized to fit over an outer diameter of the neck;
(iii) a center post positioned within the closure aperture, the center post having an expanding shoulder on an end proximate the connector section; and
(iv) opposing grip wings extending from two sides of the cap.

8. The method of claim 7, wherein a widest portion of the expanding shoulder is greater in diameter than the opening orifice.

9. The method of claim 8, wherein (i) a sealing channel is formed between an inner diameter of the closure aperture and an outer diameter of the post expanding shoulder, and (ii) a wall thickness of the neck is greater in width than the sealing channel, thereby creating a dual seal when the sealing channel engages the neck.

10. A polymer vial comprising:
(a) a tubular body having a geometric shape including (i) a neck having an opening orifice, and (ii) a closed base formed by flattening and sealing a bottom edge of the tubular body;
(b) a snap off cap integrally formed on the neck;
(c) a liquid content contained in the tubular body; and
(d) a plurality of dosage lines printed on the tubular body, the dosage lines having a non-uniform spacing corresponding to the variable volume per unit length of the vial geometric shape, wherein
each line corresponds to a dosage volume of the liquid content when the opening orifice is oriented in the vertically upward position.

11. The polymer vial of claim 10, wherein the liquid content includes a concentration of effective ingredient, and the dosage line spacing corresponds to a given mg dosage of the effective ingredient.

12. The polymer vial of claim 11, wherein mg dosage is 10 mg.

13. The polymer vial of claim 11, wherein the opening orifice has an inner diameter of approximately 0.1 inches.

14. The polymer vial of claim 11, wherein the snap off cap includes:
(i) a first end having a connector section configured to snap off of the neck upon application of force;
(ii) a second end having a closure aperture extending only partially into the first side of the cap, the closure aperture sized to fit over an outer diameter of the neck;
(iii) a center post positioned within the closure aperture, the center post having an expanding shoulder on an end proximate the connector section; and
(iv) opposing grip wings extending from two sides of the cap.

15. A polymer vial comprising:
(a) a tubular body including:
(i) a tapered neck having a neck end with an outer diameter and an opening orifice, and
(ii) a closed base formed by flattening and sealing a bottom edge of the tubular body;
(b) a cap integrally formed with the tapered neck, the cap including:
(i) a first end having a connector section configured to snap off of the tapered neck upon application of force;
(ii) a second end having a closure aperture extending only partially into the first side of the cap, the closure aperture sized to fit over the outer diameter of the neck end;
(iii) a center post positioned within the closure aperture, the center post having an expanding shoulder on an end proximate the connector section; and
(iv) opposing grip wings extending from two sides of the cap.

16. The polymer vial according to claim 15, wherein the opening orifice has an inner diameter of between 0.09 and 0.11 inches.

17. The polymer vial according to claim 15, further including connector tabs formed on two sides of the tubular body.

18. The polymer vial according to claim 15, wherein each grip wing has a width at least equal to a diameter of the closure aperture.

19. The polymer vial according to claim 15, wherein a widest portion of the expanding shoulder is greater in diameter than the opening orifice.

20. The polymer vial according to claim 15, further including dosage lines printed on the tubular body, the dosage lines corresponding to 1 ml of a liquid contained in the tubular body.
